(19) United States
(12) Patent Application Publication
(10) Pub. No.: US 2003/0111764 A1
(43) Pub. Date: Jun. 19, 2003

(54) Manufacturing method of cellulose ester film

(76) Inventor: Katsusuke Nagashima, Kobe-shi (JP)

Correspondence Address: MUSERLIAN AND LUCAS AND MERCANTI, LLP, 600 THIRD AVENUE, NEW YORK, NY, 10016, US

(21) Appl. No.: 10/236,689

(22) Filed: Sep. 6, 2002

(30) Foreign Application Priority Data
Sep. 27, 2001 (JP) 295567/2001

(51) Int. Cl. B29C 39/14; B29C 55/08

(52) U.S. Cl. 264/212; 264/290.2

(57) ABSTRACT

Disclosed is a method of manufacturing a cellulose ester film according to a solution casting film manufacturing process comprising the steps of casting a cellulose ester dope on a support to form a film on the support, peeling the film from the support, drying the peeled film, and winding the dried film around a take-up spool, wherein the following relationship is satisfied:

−4%≦MD−TD≦4%

wherein MD is represented by the following formula: MD≡(transporting speed of film at the time when the film is wound around the take-up spool/transporting speed of film on the support−1)×100(%), and TD is represented by the following formula:

TD≡(width of film at the time when the film is wound around the take-up spool/width of film immediately before peeled from the support−1)×100(%)

### FIELD OF THE INVENTION

The present invention relates to a method and equipment for manufacturing a cellulose ester film used as an optical film such as a polarizing plate protective film or an optical compensation film of a liquid crystal display.

### BACKGROUND OF THE INVENTION

A liquid crystal display is widely used as a display for a word processor or a personnel computer, since it can be directly connected to integrated circuits with low voltage and low power, and can be obtained as a thin display. The liquid crystal display has a fundamental structure in that a polarizing plate is provided on each side of a liquid crystal cell. The polarizing plate transmits only light which vibrates in a specific direction. In the liquid crystal display, the polarizing plate plays an important part in forming a visible image employing variation of molecular orientation due to application of electric field.

The polarizing plate has a general structure in which a protective film, for example, cellulose ester film such as a cellulose triacetate film or a cellulose acetate propionate film, is adhered through an adhesive such as polyvinyl alcohol to one side or both sides of a polarizing film, for example, a polyvinyl alcohol film which is saponified with an alkali, uniaxially stretched, and dyed with iodine.

The cellulose ester film is manufactured according to a solution cast film forming method.

The method comprises the steps of casting a cellulose ester dope from a die onto an endless belt support whose surface is subjected to mirror grinding, dried the cast dope during approximately one round of the belt support to form a film on the belt support, peeling the film from the belt support through a peeling roller, drying the peeled film in a drier, and winding the dried film around a take-up spool to obtain a cellulose ester film.

In the invention, a web, which a dope layer cast onto an endless belt support has been dried and has been in a state capable of being peeled from the support, is referred to as a film.

In the manufacturing method of cellulose ester film as described above, it is known that an optical property, dimensional stability, or flatness of cellulose ester film as a final product differs due to transporting conditions or drying conditions at a stage from the step of peeling the film from the support till the step of winding the film after having been dried around the take-up spool. During the step of peeling the film from the support till the step of winding the film after having been dried around the take-up spool, the film shrinks as the solvent of the film evaporates, but the degree of shrinkage or elongation of the film in the transporting direction (hereinafter referred to also as the mechanical direction) is different from that in the transverse direction on account of transporting tension applied in the mechanical direction. Molecular orientation of cellulose ester film as a final product is determined due to stress applied to the film during the step of peeling the film from the support till the step of winding the film after having been dried around the take-up spool. The difference between the degree of shrinkage or elongation of the film in the mechanical direction and that in the transverse direction produces a difference between molecular orientation of the film in the mechanical direction and that in the transverse direction, and results in a great difference between refractive index in the mechanical direction and that in the transverse direction. Accordingly, there occurs the problem in that the cellulose ester film has a retardation in planes R0 which is high, for example, more than 0.2 nm, and when applied to a polarizing plate, desired polarization properties cannot be obtained.

The retardation in planes R0 of the film is represented by the following formula:

R0≡(nx−ny)×Film thickness

Wherein nx represents refractive index in the optical delayed phase axis in planes of the film, and ny represents refractive index in the direction in planes perpendicular to the optical delayed phase axis in planes of the film.

When the sum of the degree of shrinkage or elongation of the film in the mechanical direction and that in the transverse direction is great during the step of peeling the film from the support till the step of winding the film after having been dried around the take-up spool, refractive index nz in the thickness direction of the cellulose ester film as a final product is low. Accordingly, there occurs the problem in that the cellulose ester film has a retardation in the thickness direction Rt which is high (for example, when the film has a thickness of 80 μm, Rt is more than 60 nm), and when applied to a polarizing plate, desired polarization properties cannot be obtained.

The retardation in the thickness direction Rt of the film is represented by the following formula:

Rt≡{(nx−ny)/2−nz}×Film thickness

When the cellulose ester film as a final product is allowed to stand under conditions of high temperature and high humidity, dimension of the film varies. When such a cellulose ester film is applied to a polarizing plate protective film, there occurs the problem in that a clearance is produced between a liquid crystal panel and a polarizer, resulting in a fault such as white spots.

The degree of shrinkage or elongation of the film in the transverse direction produced during the step of peeling the film from the support till the step of winding the film around the take-up spool has an influence on uniformity unevenness of the thickness in the mechanical direction of cellulose ester film as a final product, that is, flatness of the film. As a method of improving the flatness of cellulose ester film as a final product, there is known a method of stretching the film at a stage from the step of peeling the film from the support till the step of winding the film around the take-up spool (see Japanese Patent O.P.I. Publication No. 62-46626). However, this method has the problem in that improvement of flatness of the film cannot be obtained when the degree of shrinkage or elongation of the film in the transverse direction is great at a stage from the step of peeling the film from the support till the step of stretching the film. Further, there is the problem in that when the degree of stretching the film in the transverse direction is too great, the molecular orientation axis (optical delayed phase axis) of cellulose ester film as a final product fluctuates in the transverse direction of the film.

### SUMMARY OF THE INVENTION

An object of the invention is to provide a manufacturing method of cellulose ester film which overcomes the above problems, and is capable of controlling optical properties, dimensional stability or flatness of cellulose ester film as a final product.

### BRIEF EXPLANATION OF THE DRAWINGS

FIG. 1 shows a schematic view of one embodiment of the apparatus used in the method of the invention.

FIG. 2 shows a schematic view of another embodiment of the apparatus used in the method of the invention.

### DETAILED DESCRIPTION OF THE INVENTION

The present inventor has an extensive study in order to solve the above problems, and has found that a retardation in planes R0 of cellulose ester film as a final product is influenced by the difference between elongation percentage of the film in the mechanical direction and that in the transverse direction at a stage from the step of peeling the film from the support till the step of winding the film around the take-up spool, a retardation in the thickness direction Rt of cellulose ester film as a final product is influenced by the sum of elongation percentage of the film in the mechanical direction and that in the transverse direction at a stage from the step of peeling the film from the support till the step of winding the film around the take-up spool, and optical properties, dimensional stability or flatness of cellulose ester film are improved by controlling the above difference or above sum so that it falls within an appropriate range.

The present invention has been made based upon the above described. The above object of the invention can be attained by the following:

1. A method of manufacturing a cellulose ester film according to a solution casting film manufacturing process comprising the steps of casting a cellulose ester dope on a support to form a film on the support, peeling the film from the support, drying the peeled film, and winding the dried film around a take-up spool, wherein the following relationship is satisfied:

−4%≦MD−TD≦4%

wherein MD is represented by the following formula:

MD≡(transporting speed of film at the time when the film is

wound around the take-up spool/transporting speed of film

on the support−1)33 100(%), and TD is represented by the

following formula:

TD≡(width of film at the time when the film is wound around

the take-up spool/width of film immediately before peeled

from the support−1)×100(%)

2. A method of manufacturing a cellulose ester film according to a solution casting film manufacturing process comprising the steps of casting a cellulose ester dope on a support to form a film on the support, peeling the film from the support, drying the peeled film, and winding the dried film around a take-up spool,

wherein the following relationship is satisfied:

−6%≦MD+TD≦6%

wherein MD is represented by the following formula:

MD≡(transporting speed of film at the time when the film is

wound around the take-up spool/transporting speed of film

on the support−1)×100(%), and TD is represented by the

following formula:

TD≡(width of film at the time when the film is wound around

the take-up spool/width of film immediately before peeled

from the support−1)×100(%)

3. A method of manufacturing a cellulose ester film according to a solution casting film manufacturing process comprising the steps of casting a cellulose ester dope on a support to form a film on the support, peeling the film from the support, drying the peeled film, and winding the dried film around a take-up spool,

wherein the following relationships are satisfied:

−4%≦MD−TD≦4%, and −6%≦MD+TD≦6%

wherein MD is represented by the following formula:

MD≡(transporting speed of film at the time when the film is

wound around the take-up spool/transporting speed of film

on the support−1)×100(%), and TD is represented by the

following formula:

TD≡(width of film at the time when the film is wound around

the take-up spool/width of film immediately before peeled

from the support−1)×100(%)

4. The method of item 3, wherein the following relationships are further satisfied:

TD≧−4%, and MD≦−1%

5. The method of item 3, wherein the following relationship is further satisfied:

MD1≦−1%

wherein MD1 is represented by the following formula:

MD1≡(transporting speed of film at the time when the film

is wound around the take-up spool/transporting speed of

film at the time when the residual solvent content of the

film is 30% by weight−1)×100(%)

6. The method of item 4, wherein the following relationship is further satisfied:

MD1≦−1%

wherein MD1 is represented by the following formula:

MD1≡(transporting speed of film at the time when the film

is wound around the take-up spool/transporting speed of

film at the time when the residual solvent content of the

film is 30% by weight−1)×100(%)

7. The method of item 3, further comprising the step of stretching the film in the transverse direction between the step of peeling the film from the support and the step of winding the film around the take-up spool, wherein the following relationship is satisfied:

TD1≧−6%,

wherein TD1 is represented by the following formula:

TD1≡(width of film immediately before stretched/width of film immediately before peeled from the support−1)×100(%)

8. The method of item 4, further comprising the step of stretching the film in the transverse direction between the step of peeling the film from the support and the step of winding the film around the take-up spool, wherein the following relationship is satisfied:

TD1≧−6%,

wherein TD1 is represented by the following formula:

TD1≡(width of film immediately before stretched/width of film immediately before peeled from the support−1)×100(%)

9. The method of item 5, further comprising the step of stretching the film in the transverse direction between the step of peeling the film from the support and the step of winding the film around the take-up spool, wherein the following relationship is satisfied:

TD1≧−6%,

wherein TD1 is represented by the following formula:

TD1≡(width of film immediately before stretched/width of film immediately before peeled from the support−1)×100(%)

10. The method of item 3, further comprising, between the step of peeling the film from the support and the step of winding the dried film around the take-up spool, at least one step of stretching the film in the transverse direction at a stretching ratio of not more than 5%.

11. The method of item 4, further comprising, between the step of peeling the film from the support and the step of winding the dried film around the take-up spool, at least one step of stretching the film in the transverse direction at a stretching ratio of not more than 5%.

12. The method of item 5, further comprising, between the step of peeling the film from the support and the step of winding the dried film around the take-up spool, at least one step of stretching the film in the transverse direction at a stretching ratio of not more than 5%.

13. The method of item 6, further comprising, between the step of peeling the film from the support and the step of winding the dried film around the take-up spool, at least one step of stretching the film in the transverse direction at a stretching ratio of not more than 5%.

14. A cellulose ester film manufactured by the method of any one of items 1 through 13.

15. A polarizing plate comprising a protective film comprised of the cellulose ester film as described in item 14.

21. A method of manufacturing a cellulose ester film according to a solution casting film manufacturing process comprising the steps of casting a cellulose ester dope on a support to form a film on the support, peeling the film from the support, drying the peeled film, and winding the dried film around a take-up spool,

wherein the following relationship is satisfied:

−4%≦MD−TD≦4%

wherein MD represents an elongation percentage in the mechanical direction of film at a stage from the step of peeling the film from the support till the step of winding the dried film around the take-up spool, and TD represents an elongation percentage in the transverse direction of film at a stage from the step of peeling the film from the support till the step of winding the dried film around the take-up spool.

22. A method of manufacturing a cellulose ester film according to a solution casting film manufacturing process comprising the steps of casting a cellulose ester dope on a support to form a film on the support, peeling the film from the support, drying the peeled film, and winding the dried film around a take-up spool, wherein the following relationship is satisfied:

−6%≦MD+TD≦6%

wherein MD represents an elongation percentage in the mechanical direction of film at a stage from the step of peeling the film from the support till the step of winding the dried film around the take-up spool, and TD represents an elongation percentage in the transverse direction of film at a stage from the step of peeling the film from the support till the step of winding the dried film around the take-up spool.

23. A method of manufacturing a cellulose ester film according to a solution casting film manufacturing process comprising the steps of casting a cellulose ester dope on a support to form a film on the support, peeling the film from the support, drying the peeled film, and winding the dried film around a take-up spool,

wherein the following relationships are satisfied:

−4%≦MD−TD≦4%, and −6%≦MD+TD≦6%

wherein MD represents an elongation percentage in the mechanical direction of film at a stage from the step of peeling the film from the support till the step of winding the dried film around the take-up spool, and TD represents an elongation percentage in the transverse direction of film at a stage from the step of peeling the film from the support till the step of winding the dried film around the take-up spool.

24. The method of item 23, wherein the following relationships are further satisfied:

TD≧−4%, and MD≦−1%

25. The method of item 23 or 24, wherein the following relationship is further satisfied:

MD1≦−1%

wherein MD1 represents an elongation percentage in the mechanical direction of film at the region where the residual solvent content of the film is not more than 30% by weight at a stage from the step of peeling the film from the support till the step of winding the dried film around the take-up spool.

26. The method of item 23, 24 or 25, further comprising the step of stretching the film in the transverse direction at a stage from the step of peeling the film from the support till the step of winding the film around the take-up spool, wherein the following relationship is satisfied:

TD1≧−6%,

wherein TD1 represents elongation percentage in the transverse direction of the film at a stage from the step of peeling the film from the support till the step of firstly stretching the film in the transverse direction.

27. The method of any one of items 23 through 26, wherein the method further comprises at least one step of stretching the film in the transverse direction between the step of peeling the film from the support and the step of winding the dried film around the take-up spool, the film being stretched at the stretching step in the transverse direction at a stretching ratio of not more than 5%.

28. A cellulose ester film manufactured by the method of any one of items 21 through 27.

29. A polarizing plate comprising a protective film comprised of the cellulose ester film as described in item 28.

The cellulose ester film manufacturing method according to item 1 is a method of manufacturing a cellulose ester film according to a solution casting film manufacturing process comprising the steps of casting a cellulose ester dope on a support to form a film on the support, peeling the film from the support, drying the peeled film, and winding the dried film around a take-up spool, wherein the following relationship is satisfied:

−4%≦MD−TD≦4%

wherein MD represents an elongation percentage in the mechanical direction of film at a stage from the step of peeling the film from the support till the step of winding the dried film around a take-up spool, and TD represents an elongation percentage in the transverse direction of film at a stage from the step of peeling the film from the support till the step of winding the dried film around a take-up spool.

In the above, MD and TD are represented by the following formulae:

MD≡(transporting speed of film at the time when the film is

wound around the take-up spool/transporting speed of film

on the support−1)×100(%) (a)

TD≡(width of film at the time when the film is wound around

the take-up spool/width of film immediately before peeled

from the support−1)×100(%) (b)

In item 1, when the relationship −4%≦MD−TD≦4% is satisfied, the difference between refractive index in the optical delayed axis direction (nx) and refractive index perpendicular to the optical delayed axis direction (ny) in planes of cellulose ester film as a final product is small, and a retardation in planes R0 is small, and a retardation in planes R0 is low, for example, not more than 0.2 nm, whereby polarization properties are improved. When MD−TD falls outside the above range, the difference between degree of shrinkage or elongation of the film in the mechanical direction and that in the transverse direction at a stage from the step of peeling the film from the support till the step of winding the film around the take-up spool is great, and the molecular orientation of cellulose ester film as a final product greatly differs in the mechanical direction and in the transverse direction, resulting in a great difference between the refractive indexes (nx) and (ny) as described above, and in a high retardation in planes R0.

The cellulose ester film manufacturing method according to item 2 is a method of manufacturing a cellulose ester film according to a solution casting film manufacturing process comprising the steps of casting a cellulose ester dope on a support to form a film on the support, peeling the film from the support; drying the peeled film, and winding the dried film around a take-up spool, wherein the following relationship is satisfied:

−6%≦MD+TD≦6%

wherein MD represents an elongation percentage in the mechanical direction of film at a stage from the step of peeling the film from the support till the step of winding the dried film around a take-up spool, and TD represents an elongation percentage in the transverse direction of film at a stage from the step of peeling the film from the support till the step of winding the dried film around a take-up spool. Herein, MD and TD are represented by the above formulae (a) and (b), respectively.

In item 2, when the relationship −6%≦MD+TD≦6% is satisfied, a refractive index in the thickness direction of cellulose ester film as a final product is small, and a retardation in the thickness direction Rt is high, whereby desired optical properties can be obtained. When MD+TD>6%, a refractive index in the thickness direction nz of cellulose ester film as a final product is too high, a retardation in the thickness direction Rt is too low, and for example, when the thickness of the film is 80 μm, Rt is less than 50 nm. When MD+TD<−6%, a refractive index in the thickness direction nz of cellulose ester film as a final product is too low, a retardation in the thickness direction Rt is too high, and for example, when the thickness of the film is 80 μm, Rt is more than 60 nm. In either case above, desired optical properties can be obtained.

The cellulose ester film manufacturing method according to item 3 is a method of manufacturing a cellulose ester film according to a solution casting film manufacturing process comprising the steps of casting a cellulose ester dope on a support to form a film on the support, peeling the film from the support, drying the peeled film, and winding the dried film around a take-up spool, wherein the following relationships are satisfied:

−4%≦MD−TD≦4%, and −6%≦MD+TD≦6%

wherein MD represents an elongation percentage in the mechanical direction of film at a stage from the step of peeling the film from the support till the step of winding the dried film around the take-up spool, and TD represents an elongation percentage in the transverse direction of film at a stage from the step of peeling the film from the support till the step of winding the dried film around the take-up spool. Herein, MD and TD are represented by the above formulae (a) and (b), respectively.

In claim 3, the relationships −4%≦MD−TD≦4%, and −6%≦MD+TD≦6% are satisfied, and the same as described in claim 1 or 2 above applies to claim 3. The method of claim 3 can provide a cellulose ester film with improved polarization property and desired optical properties.

The cellulose ester film manufacturing method according to item 4 is the method of item 3, wherein the relationships TD≧−4%, and MD≦−1% are further satisfied.

Herein, MD and TD are represented by the above formulae (a) and (b), respectively.

In item 4, when the relationships TD≧−4%, and MD≦−1% are satisfied, stress applied to the film during drying is low, and residual stress of cellulose ester film as a final product is low, whereby for example, dimensional stability of the film is improved under high temperature and high humidity.

The cellulose ester film manufacturing method according to item 5 or 6 is the method of item 3 or 4, wherein the following relationship is further satisfied:

MD1≦−1%

wherein MD1 represents elongation percentage in the mechanical direction of film at the region where the residual solvent content of the film is not more than 30% by weight at a stage from the step of peeling the film from the support till the step of winding the dried film around the take-up spool.

In item 5 or 6, the residual solvent content of the film is represented by the following formula:

Residual solvent content (% by weight)={(A−B)/B}×100

wherein A represents weight of film to be measured, and B represents weight of film obtained after the film to be measured was dried at 110° C. for three hours. In the invention, the residual solvent content of the film is defined by the above formula.

In item 5 or 6, MD1 is represented by the following formula:

MD1≡(transporting speed of film at the time when the film

is wound around the take-up spool/transporting speed of

film at the time when the residual solvent content of the

film is 30% by weight−1)×100(%) (C)

In the method of item 5, wherein the relationship MD1≦−1% is satisfied wherein MD1 represents elongation percentage in the mechanical direction of film at the region where the residual solvent content of the film is not more than 30% by weight at a stage from the step of peeling the film from the support till the step of winding the dried film around the take-up spool, dimensional stability of cellulose ester film as a final product is improved. Drying of the film after peeled from the support is carried out at relatively low temperature (not more than 80° C.) at the region where the residual solvent content of the film is more than 30% by weight, and carried out at relatively high temperature (not less than 100° C.) at the region where the residual solvent content of the film is not more than 30% by weight. The elongation percentage in the mechanical direction of the film at the region where the residual solvent content of the film is not more than 30% by weight has a great influence on dimensional stability of cellulose ester film as a final product. Accordingly, when MD1, which represents elongation percentage in the mechanical direction of film at that region, is not more than −1%, dimensional stability of the film as a final product is improved.

The cellulose ester film manufacturing method according to item 7, 8 or 9 is the method of item 3, 4 or 5 comprising the step of stretching the film in the transverse direction at a stage from the step of peeling the film from the support till the step of winding the film around the take-up spool, wherein the following relationship is further satisfied:

TD1≧−6%,

wherein TD1 represents elongation percentage in the transverse direction of the film at a stage from the step of peeling the film from the support till the step of firstly stretching the film in the transverse direction.

In item 7, 8 or 9, TD1 is represented by the following formula:

TD1≡(width of film immediately before stretched/width of film immediately before peeled from the support−1)×100(%) (d)

In the method of item 7, 8 or 9, when TD1 is not less than −6%, wherein TD1 represents elongation percentage in the transverse direction of the film at a stage from the step of peeling the film from the support till the step of stretching the film in the transverse direction, flatness of cellulose ester film as a final product is improved. The reason that the film is stretched in the transverse direction is because unevenness of the cellulose ester film as a final product is minimized and flatness of the film is improved. When TD1, representing elongation percentage in the transverse direction of the film at a stage from the step of peeling the film from the support till the step of stretching the film in the transverse direction, is less than −6%, flatness of the film cannot be obtained.

In items 1 through 9, MD, MD1 and/or TD, TD1 are controlled, adjusting drying conditions of the film or a tension applied to the film.

The cellulose ester film manufacturing method according to item 10, 11, 12 or 13 is the method of item 3, 4, 5 or 6, wherein the method further comprises, between the step of peeling the film from the support and the step of winding the dried film around the take-up spool, at least one step of stretching the film in the transverse direction at a stretching ratio of not more than 5%.

The stretching ratio in item 10, 11, 12 or 13 equals to an elongation percentage in the transverse direction of the film TD2, and is represented by the following formula:

TD2≡(width of film immediately after stretched/width of film immediately before stretched−1)×100(%) (e)

In item 10, 11, 12 or 13, when the film is stretched at the stretching step in the transverse direction at a stretching ratio of not more than 5%, fluctuation of the molecular orientation axis in the transverse direction (optical delayed phase axis) of cellulose ester film as a final product is minimized, and optical properties of the film are improved. When the film is stretched at the stretching step in the transverse direction at a stretching ratio of more than 5%, fluctuation of the molecular orientation axis in the transverse direction (optical delayed phase axis) of cellulose ester film as a final product is great.

The cellulose ester film described in item 14 is a cellulose ester film manufactured by the method of any one of items 1 through 13.

The polarizing plate of item 15 is a polarizing plate comprising a protective film comprised of the cellulose ester film as described in item 14.

Next, embodiments of the invention will be explained referring to figures.

Materials used in the cellulose ester film manufacturing method of the invention will be explained below.

Cellulose esters constituting a cellulose ester dope may be those in which cellulose selected from those of linter pulp, tree pulp and kenaf pulp is reacted with acetic anhydride, propionic anhydride, or butyric anhydride according to an ordinary method. Among these are preferred cellulose triacetate, cellulose acetate propionate, cellulose acetate butyrate, and cellulose acetate propionate butyrate each having a total acyl substitution degree of 2.5 to 3.0. The cellulose ester above has an acetyl substitution degree of preferably at least 1.5. The acyl substitution degree of the cellulose ester can be measured according to ASTM-D817-96. The number average molecular weight of the cellulose ester is preferably 70,000 to 300,000, and more preferably 80,000 to 200,000, in providing good mechanical strength as a cellulose ester film. Generally, cellulose esters are obtained in flake form after the reaction and washing, and are used in that form. Spherical cellulose esters with a particle size of 0.05 to 2.0 mm can provide increased dissolution speed.

The cellulose ester film ordinarily contains a UV absorbent. The UV absorbent is preferably a UV absorbent which has excellent absorption of ultraviolet light having a wavelength of 370 nm or less, and has reduced absorption of visible light having a wavelength of 400 nm or more in clearly displaying a liquid crystal image. The UV absorbent has a transmittance at 370 nm of preferably not more than 10%, more preferably not more than 5%, and most preferably not more than 2%. Examples of the UV absorbent above include an oxybenzophenone compound, a benzotriazole compound, a salicylic acid ester compound, a benzophenone compound, a cyanoacrylate compound and a nickel complex compound. The benzotriazole compound, which is more colorless, is preferred. Examples of a commercially available benzotriazole compound include TINUBIN 109, 171, 326, 327, and 328, each produced by Ciba Specialty Chemicals Co., Ltd. The UV absorbent may be used in combination of two or more kinds thereof. The UV absorbent may be added to a dope in the form of a solid or in the form of a solution in which the UV absorbent is dissolved in an organic solvent such as alcohol, methylene chloride, methyl acetate or dioxolane. Undissolution materials such as inorganic powder are dispersed in a mixture of an organic solvent and cellulose ester employing a dissolver or a sand mill, and added to a dope. The UV absorbent addition amount is preferably 0.5 to 20% by weight, more preferably 0.6 to 5.0% by weight, and most preferably 0.6 to 2.0% by weight, based on the cellulose ester.

The cellulose ester film contains a matting agent or other particles to improve a sliding property, an anti-blocking property or an abrasion resistance. Examples of the particles include particles of inorganic compounds such as silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate, and cross-linked polymer particles. Among these, silicon dioxide is preferred in reducing a haze of the cellulose ester film. The secondary order particles of the particles have an average particle diameter of preferably 0.01 to 1.0 μm, and the particle content of the film is preferably 0.005 to 0.3% by weight. The particles such as silicon dioxide particles are often surface treated with an organic compound, and such surface treated particles are preferable in giving a reduced haze to the film. Examples of the organic compound used in the surface treatment include halogenated silanes, alkoxysilanes, silazanes, and siloxanes. Particles having a larger average particle diameter has a high matting effect, and particles having a smaller average particle diameter has a good transparency. The primary order particles of the particles have an average particle diameter of preferably 5 to 50 nm, and more preferably 7 to 14 nm. The particles exist as aggregates in the cellulose ester film, and provide concavities and convexities of preferably 0.01 to 1.0 μm on the film surface. Examples of the silicon dioxide particles commercially available include Aerosil 200, 200V, 300, R972, R972V, R974, R812, R202, OX50, or TT600 (each produced by Nihon Aerosil Co., Ltd.), and Aerosil R972, R972V, R974, R202 or R812 are preferred. The particles may be used as a mixture of two or more kinds.

A plasticizer such as a phthalate or a phosphate is contained in the cellulose ester film. Examples of the phosphate include triphenyl phosphate, tricresyl phosphate, cresyldiphenyl phosphate, octyldiphenyl phosphate, diphenylbiphenyl phosphate, trioctyl phosphate, and tributyl phosphate. Examples of the phthalateinclude diethyl phthalate, dimethoxyethyl phthalate, dimethyl phthalate, dioctyl phthalate, dibutyl phthalate, and di-2-ethylhexyl phthalate. Examples of glycolic acid ester include triacetin, tributyrin, butyl phthalyl butyl glycolate, ethyl phthalyl ethyl glycolate, or methyl phthalyl ethyl glycolate, and a glycerin ester. The phthalate or phosphate plasticizer is preferred. These plasticizers may be used as an admixture of two or more kinds thereof.

Next, a preparing method of a dope containing the materials described above will be explained. Cellulose ester in the flake form is dissolved, while stirring, in organic solvents mainly comprised of a good solvent for the cellulose ester, employing a dissolution vessel, and thereby a dope is prepared. As the dissolution methods, there are various methods such as a method in which dissolution is carried out at a normal atmospheric pressure, a method in which dissolution is carried out at while heating a temperature lower than the boiling point of the primary solvent, a method in which dissolution is carried out while heating at a temperature higher than the boiling point of the main solvent under increased pressure, a cooling dissolution method as disclosed in Japanese Patent O.P.I. Publication Nos. 9-95544, 9-95557, and 9-95538, a method in which dissolution is carried out at a high pressure as disclosed in Japanese Patent O.P.I. Publication No. 11-21379. The resultant dope is filtered employing filter materials, is then defoamed, and is subsequently pumped to the next process. The cellulose ester concentration of the dope is preferably from 10 to 40% by weight, and more preferably from 15 to 30% by weight. In order to add the organic polymer described above to the dope, the organic polymer may be added to the dope in the form of a solution in which the organic polymer is dissolved in an organic solvent, and may be directly added to the dope in the form of a solid. In the latter case, the polymer is added to the dope so that the polymer neither precipitates nor phase separates in the dope.

An organic solvent used in the preparation of a cellulose ester dope is preferably a mixture of a good solvent of cellulose ester and a poor solvent of cellulose ester in view of production efficiency. The mixture of the good solvent and the poor solvent is preferably a mixture containing the good solvent in an amount of from 70 to 98% by weight, and the poor solvent in an amount of from 2 to 30% by weight. The good solvent herein is a solvent alone dissolving cellulose ester used, and the poor solvent herein is a solvent alone dissolving no cellulose ester.

Examples of the good solvent of the cellulose ester include methyl acetate, ethyl acetate, amyl acetate, ethyl formate, acetone, cyclohexanone, methyl acetoacetate, tetrahydrofuran, 1,3-dioxolan, 4-methyl-1,3-dioxolan, 1,4-dioxane, 2,2,2-trifluoroethanol, 2,2,3,3-tetrafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, nitroethane, 2-pyrrolidone, N-methyl-2-pyrrolidone, 1,3-dimethyl-2-imidazolidinone, methylene chloride or bromopropane. Of these, methyl acetate, acetone and methylene chloride are preferably used. However, an organic solvent containing no chloride is preferable in view of environmental problem, and preferably methyl acetate.

A combined use of the above described good solvent and a lower alcohol such as methanol, ethanol or butanol is preferable in that solubility of cellulose ester in a solvent is increased and viscosity of a cellulose ester dope is reduced. Ethanol, which has a lower boiling point, and is less harmful, is especially preferable. Examples of the poor solvent include methanol, ethanol, n-butanol, cyclohexane, acetone, and cyclohexanone.

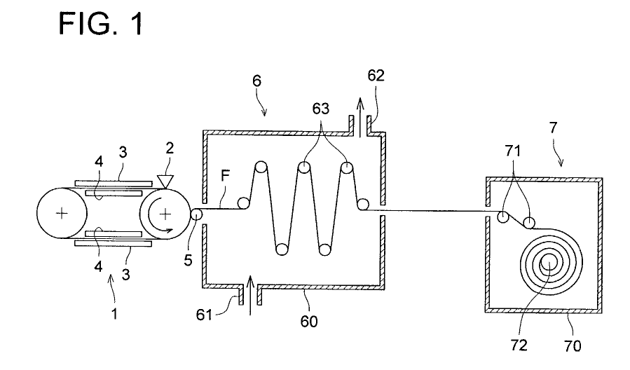

Next, one embodiment of an apparatus used in the cellulose ester film manufacturing method of the invention will be explained referring to FIG. 1.

In FIG. 1, the cellulose ester film manufacturing equipment is comprised of support 1, which is an endless metal belt having a surface subjected to mirror grinding, die 2 for casting a cellulose ester dope on the support 1, heating apparatuses 3 and 4 for heating the cast dope to form film F, the heating apparatuses being arranged on the upper and lower sides of the support 1, web peeling roller 5 for peeling the film F from the support 1, drying apparatus 6 for drying the film F peeled from the support 1, and film take-up apparatus 7 for winding up the dried film F. As the support, a metal drum may be used instead of the endless metal belt.

Drying apparatus 6 is one comprising housing 60 with heated air inlet 61 and heated air outlet 62 in which staggered plural transporting rollers 63 are provided. In the drying apparatus 6, the film F is dried with heated air introduced from the heated air inlet 61 while transported through all the transporting rollers 63 in the housing 60. The film take-up apparatus 7 comprises housing 70 and provided therein, plural transporting rollers 71 and take-up spool 72. The film F from the drying apparatus 6 is transported through all the transporting rollers 71 in the housing 70, and then wound up by the take-up spool 72.

A cellulose ester film is manufactured employing the above manufacturing equipment as follows.

A cellulose ester dope is cast on the support 1 from the die 2 to form a web, and heated by the heating apparatuses 3 and 4 until the residual solvent content of the web is 10 to 200% by weight to form film F on the support 1. The resulting film F is peeled from the support 1 by the peeling roller 5, and transported into the housing 60 of the drying apparatus 6. In the drying apparatus 6, the film F is dried with heated air introduced from the heated air inlet 61 while transported through the plural transporting rollers 63 in the housing 60. The dried film F is supplied into the film take-up apparatus 7, transported through the plural transporting rollers 71, and then wound around the take-up spool 72. The residual solvent content of the film F at the winding step is preferably not more than 1% by weight. Thus, the cellulose ester film is manufactured.

Drying condition or transporting tension is adjusted so that the relationships, −4%≦MD−TD≦4% and/or −6%≦MD+TD≦6% are satisfied, the relationships, −4%≦MD−TD≦4%, −6%≦MD+TD≦6%, TD≧−4%, and MD≦−1% are satisfied, or the relationships, −4%≦MD−TD≦4%, −6%≦MD+TD≦6%, and MD1≦−1% are satisfied, wherein MD represents elongation percentage in the mechanical direction of the film F at a stage from the step of peeling the film F from the support 1 till the step of winding the film F after having been dried around the take-up spool, TD represents elongation percentage in the transverse direction of the film F at a stage from the step of peeling the film F from the support 1 till the step of winding the film F after having been dried around the take-up spool, and MD1 represents elongation percentage in the mechanical direction of the film F at the region where the residual solvent content of the film is not more than 30% by weight at a stage from the step of peeling the film F from the support 1 till the step of winding the film F after having been dried around the take-up spool.

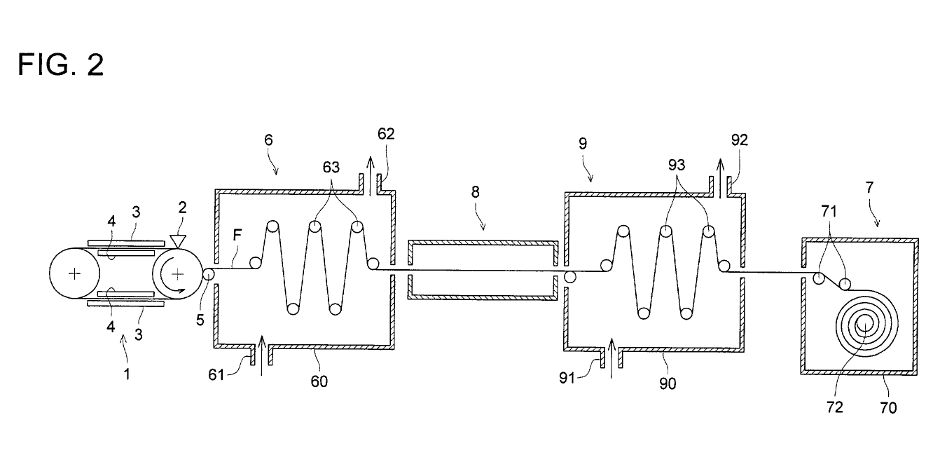

FIG. 2 is another embodiment of an apparatus used in the cellulose ester film manufacturing method of the invention.

The cellulose ester film manufacturing equipment as shown in FIG. 2 is distinguished from that as shown in FIG. 1 in that tenter 8, which holds both edges in the transverse direction of the drying film F to keep the film width constant, or stretches the dried film F in the transverse direction, and a second drying apparatus 9, which further dries the film F whose width has been controlled in the tenter 8, are provided between the drying apparatus 6 (hereinafter referred to also as first drying apparatus 6) and the film take-up apparatus 7. In FIG. 2, the same numerals of FIG. 1 represented the same items as denoted in FIG. 1.

The drying apparatus 9 is one comprising housing 90 with heated air inlet 91 and heated air outlet 92 in which staggered plural transporting rollers 93 are housed. In the drying apparatus 9, the film F is dried with heated air introduced from the heated air inlet 91 while transported through all the transporting rollers 93 in the housing 90.

Cellulose ester film can be manufactured employing the above manufacturing equipment as follows.

The stage from the step of casting a dope on the support 1 from the die 2 till the step of drying the film F in the first drying apparatus 6 is carried out in the same manner as in the apparatus of FIG. 1, except that the film F is dried in the first drying apparatus 6 to have a residual solvent content of 5 to 80% by weight.

The film F dried in the first drying apparatus 6 is transported into the tenter 8, in which the film F is heated and dried while holds both edges in the transverse direction of the film F to keep the film width constant, or stretches the film F in the transverse direction. The stretching ratio of the film F (elongation percentage in the transverse direction TD2 of film) in the tenter 8 is adjusted to be not more than 5%. The residual solvent content of the film F after having passed through the tenter 8 is preferably 3 to 50% by weight.

The film F whose width is controlled in the tenter 8 is transported into the housing 90 of the second drying apparatus 9, and dried with heated air introduced from the heated air inlet 91 while transported through the plural transporting rollers 93 in the housing 90. The film take-up apparatus 7 comprises housing 70 and provided therein, plural transporting rollers 71 and take-up spool 72. The film F from the second drying apparatus 9 is conveyed into the film take-up apparatus 7, transported through the plural transporting rollers 71, and then wound around the take-up spool 72. The residual solvent content of the film F at the winding step is preferably not more than 1% by weight. Thus, the cellulose ester film is manufactured.

Drying condition or transporting tension is adjusted so that the relationships, −4%≦MD−TD≦4% and/or −6%≦MD+TD≦6% are satisfied, the relationships, −4%≦MD−TD≦4%, −6%≦MD+TD≦6%, TD≧−4%, and MD≦−1% are satisfied, the relationships, −4%≦MD−TD≦4%, −6%≦MD+TD≦6%, and MD1≦−1% are satisfied, or −4%≦MD−TD≦4%, −6%≦MD+TD≦6%, and TD1≦−6% are satisfied, wherein MD represents elongation percentage in the mechanical direction of the film F at a stage from the step of peeling the film F from the support 1 till the step of winding the film F after having been dried around the take-up spool, TD represents elongation percentage in the transverse direction of the film F at a stage from the step of peeling the film F from the support 1 till the step of winding the film F after having been dried around the take-up spool, MD1 represents elongation percentage in the mechanical direction of the film F at the region where the residual solvent content of the film is not more than 30% by weight at a stage from the step of peeling the film F from the support 1 till the step of winding the film F after having been dried around the take-up spool, and TD1 represents elongation percentage in the transverse direction of the film F at a stage from the step of peeling the film F from the support 1 till the step of stretching the film F in the transverse direction in the tenter 8.

In FIG. 2, one tenter 8 is provided between the first drying apparatus 6 and the second drying apparatus 9, but the number of tenters or the positions, at which tenters are provided, can be varied.

Next, the present invention will be explained employing examples and comparative examples. In the following examples and comparative examples were employed the apparatus as shown in FIG. 2.

### EXAMPLES 1 THROUGH 4 AND COMPARATIVE EXAMPLE 1

A dope was prepared employing 100 parts by weight of cellulose triacetate and 500 parts by weight of methylene chloride. The resulting dope was cast on the support 1 from the die 2 in a casting amount adjusted so that the thickness of the film at the winding step of the film after having been dried was 80 μm, and dried by heating in the heating apparatuses 3 and 4 to form, on the support 1, a film F having a residual solvent content of 10 to 200% by weight. The film F formed on the support 1 was peeled from the support 1 through the peeling roller 5, and dried in the first drying apparatus 6. The dried film F was conveyed to the tenter 8, and further dried in the tenter 8 in which both edges in the transverse direction of the film F were held to keep the film width constant, or the film F was stretched in the transverse direction. Subsequently, the film F, whose width had been controlled, was dried in the second drying apparatus 9 to obtain a film F having a residual solvent content of not more than 1% by weight. The dried film F was conveyed to the take-up apparatus 7, and wound around the take-up roller 72. Thus, cellulose triacetate film with a thickness of 80 mm was prepared.

The elongation percentage in the mechanical direction MD of the film F and the elongation percentage in the transverse direction TD of the film at a stage from the step of peeling the film F from the support 1 till the step of winding the film F after having been dried around the take-up spool were varied by adjusting drying conditions, transporting tension, or stretching ratio in the tenter 8. Herein, MD and TD are represented by the following formula:

MD=(transporting speed of film at the time when the film is

wound around the take-up spool/transporting speed of film

on the support−1)×100(%)

TD=(width of film at the time when the film is wound around

the take-up spool/width of film immediately before peeled

from the support−1)×100(%).

A retardation in planes R0 and a retardation Rt in the thickness direction of the thus obtained cellulose triacetate film were measured through an automatic birefringence meter KOBLA 21ADH produced by Oji Keisoku Kiki Co., Ltd. Dimensional stability in the mechanical direction and in the transverse direction of the film were determined according to the following method. The film was cut into a 100 mm square film sample so that the two opposed sides was in parallel with the mechanical direction and the other two opposed sides were in parallel with the transverse direction. The lengths L1 in the mechanical direction and in the transverse direction of the sample were measured through a microscope at an accuracy of 1/1000 mm. After that, the sample was allowed to stand at 80° C. and at 90% RH for 50 hours, and then to stand at 23° C. and at 55% RH for 8 hours, and the lengths L2 in the mechanical direction and in the transverse direction of the resulting sample were measured through a microscope at an accuracy of 1/1000 mm. The dimensional stability of the film is represented by the formula:

Dimensional stability of film={(L1−L2)/L1×100}(%)

The results of Examples 1 through 4 and Comparative example 1 are shown in Table 1.

TABLE 1

| | Elongation | Elongation | | | | | | |
|---|---|---|---|---|---|---|---|---|
| | percentage | percentage | | | | Retardation | | |
| | in the | in the | | | | in the | | |
| | mechanical | transverse | | | | thickness | Dimensional stability | |
| | direction | direction | | | Retardation | direction | In the | In the |
| | MD | TD | MD − | MD + | in places | Rt | mechanical | transverse |
| | (%) | (%) | TD | TD | R0 (nm) | (nm) | direction | direction |
| Example 1 | −2 | −5 | 3 | −7 | 1.9 | 45 | −0.1 | 0.3 |
| Example 2 | −0.5 | −5 | 4.5 | −5.5 | 3.0 | 53 | −0.3 | 0.3 |
| Example 3 | −1.5 | −4 | 2.5 | −5.5 | 1.6 | 53 | −0.2 | 0.2 |
| Example 4 | −2 | −3 | 1 | −5 | 0.7 | 55 | −0.05 | 0.1 |
| Comparative | −0.5 | −6 | 5.5 | −6.5 | 3.7 | 48 | −0.3 | 0.4 |
| Example 1 | | | | | | | | |

### EXAMPLES 5 AND 6

A cellulose triacetate film was prepared in the same manner as in Examples 1 through 4 and Comparative Example 1 above.

In the above preparation, MD2, MD1, or TD was varied, adjusting a drying condition, a transporting tension, or a stretching ratio of the film in the tenter.

MD2 shows elongation percentage in the mechanical direction of the film F at a region giving a residual solvent content of the film not less than 30% by weight at a stage from the step of peeling the film F from the support 1 till the step of winding the film F after dried around the take-up spool, which is represented by the formula:

MD2=(transporting speed of film at the time when the

residual solvent content of the film is 30% by weight/transporting

speed of film on the support−1)×100(%)

MD1 shows elongation percentage in the mechanical direction of the film F at a region giving a residual solvent content of the film of not more than 30% by weight at a stage from the step of peeling the film F from the support 1 till the step of winding the film F after dried around the take-up spool, which is represented by the formula:

MD1=(transporting speed of film at the time when the film

is wound around the take-up spool/transporting speed of

film at the time when the residual solvent content of the

film is 30% by weight−1)×100(%)

TD shows elongation percentage in the transverse direction of the film F at a stage from the step of peeling the film F from the support 1 till the step of winding the film F after dried around the take-up spool, which is represented by the formula:

TD=(width of film at the time when the film is wound around

the take-up spool/width of film immediately before peeled

from the support−1)×100(%)

Thus, cellulose triacetate films (Examples 5 and 6) were prepared, and were evaluated for dimensional stability in the same manner as in Examples 1 through 4 and Comparative Example 1 above. The results are shown in Table 2.

TABLE 2

| | Elongation | | | Elongation | | |
|---|---|---|---|---|---|---|
| | percentage | | | percentage | Dimensional | |
| | in the | | | in the | stability (%) | |
| | Mechanical | | | transverse | In the | In the |
| | direction | | MD2 + | direction | mechanical | transverse |
| | MD2 | MD1 | MD1 | TD (%) | direction | direction |
| Example | −0.5 | −1.5 | −2.0 | −3.5 | −0.05 | +0.15 |
| 5 | | | | | | |
| Example | −1.5 | −0.5 | −2.0 | −3.5 | −0.15 | +0.15 |
| 6 | | | | | | |

### EXAMPLES 7 AND 8

A cellulose triacetate film was prepared in the same manner as in Examples 1 through 4 and Comparative Example 1 above.

In the above preparation, MD, TD1, TD2 or TD3 was varied, adjusting a drying condition, a transporting tension, or a stretching ratio of the film in the tenter.

MD shows elongation percentage in the mechanical direction of film F at a stage from the step of peeling the film F from the support 1 till the step of winding film F after dried around the take-up spool, which is represented by the formula:

MD=(transporting speed of film at the time when the film is

wound around the take-up spool/transporting speed of film

on the support−1)×100(%)

TD1 shows elongation percentage in the transverse direction of the film F at a stage from the step of peeling the film F from the support 1 till the step of transporting (conveying) the film to the tenter, which is represented by the formula:

TD1=(width of film immediately before stretched/width of film immediately before peeled from the support−1)×100(%)

TD2 shows elongation in the tenter (8), that is, elongation percentage in the transverse direction of the film F at a stage from the step immediately before stretching the film F till the step immediately after stretching the film F, which is represented by the formula:

TD2=(width of film immediately after stretched/width of film immediately before stretched−1)×100(%)

TD3 shows elongation percentage in the transverse direction of the film F at a stage from the step transporting the film F out of the tenter till the step of winding the film F around the take-up spool, which is represented by the formula:

TD3=(width of film immediately after stretched/width of

film at the time when the film is wound around the take-up

spool−1)×100(%)

Thus, cellulose triacetate films (Examples 7 and 8) were prepared. The orientation angle thereof was measured through an automatic birefringence analyzer KOBRA 21ADH produced by Oji Keisokukiki Co., Ltd. Further, flatness thereof was determined according to the following procedures:

The thickness of the film was measured through a laser confocal displacement meter LT-8010, produced by Keyence Corporation, and the difference between the maximum thickness and the minimum thickness was determined.

The results are shown in Table 3.

TABLE 3

| | Elongation | Elongation | | | | | |
|---|---|---|---|---|---|---|---|
| | percentage | percentage | | | | | |
| | in the | in the | | | | | Orien- |
| | mechanical | transverse | | | TD1 + | Flat- | tation |
| | direction | direction (%) | | | TD2 + | ness | angle |
| | MD (%) | TD1 | TD2 | TD3 | TD3 | (μm) | (°) |
| Example 7 | −2 | −4 | 3 | −0.5 | −1.5 | 0.3 | ±5 |
| Example 8 | −2 | −7 | 6 | −0.5 | −1.5 | 0.8 | ±12 |

The above result shows that when the total elongation percentage (TD1+TD2+TD3) in the transverse direction is the same, a film having a smaller TD2 (elongation in the tenter) provides better flatness.

### EFFECTS OF THE INVENTION

The present invention provides a cellulose ester film with a low retardation in planes which improves polarization properties.

The present invention provides a cellulose ester film with a high retardation in the thickness direction which provides desired optical characteristics.

The present invention provides a cellulose ester film with a low retardation in planes and with a high retardation in the thickness direction, which provides improved polarization properties and desired optical characteristics.

What is claimed is:

1. A method of manufacturing a cellulose ester film according to a solution casting film manufacturing process comprising the steps of:
casting a cellulose ester dope on a support to form a film on the support;
peeling the film from the support;
drying the peeled film; and
winding the dried film around a take-up spool;
wherein the following relationship is satisfied:
−4%≦MD−TD≦4%
wherein MD is represented by the following formula:
MD≡(transporting speed of film at the time when the film is
wound around the take-up spool/transporting speed of film
on the support−1)×100(%), and TD is represented by the
following formula:
TD≡(width of film at the time when the film is wound around
the take-up spool/width of film immediately before peeled
from the support−1)×100(%)

2. A method of manufacturing a cellulose ester film according to a solution casting film manufacturing process comprising the steps of:
casting a cellulose ester dope on a support to form a film on the support;
peeling the film from the support;
drying the peeled film; and
winding the dried film around a take-up spool;
wherein the following relationship is satisfied:
−6%≦MD+TD≦6%
wherein MD is represented by the following formula:
MD≡(transporting speed of film at the time when the film is
wound around the take-up spool/transporting speed of film
on the support−1)×100(%), and TD is represented by the
following formula:
TD≡(width of film at the time when the film is wound around
the take-up spool/width of film immediately before peeled
from the support−1)×100(%)

3. A method of manufacturing a cellulose ester film according to a solution casting film manufacturing process comprising the steps of:
casting a cellulose ester dope on a support to form a film on the support;
peeling the film from the support;
drying the peeled film; and
winding the dried film around a take-up spool,
wherein the following relationships are satisfied:
−4%≦MD−TD≦4%, and −6%≦MD+TD≦6%
wherein MD is represented by the following formula:
MD≡(transporting speed of film at the time when the film is
wound around the take-up spool/transporting speed of film
on the support−1)×100(%), and TD is represented by the
following formula:
TD≡(width of film at the time when the film is wound around
the take-up spool/width of film immediately before peeled
from the support−1)×100(%)

4. The method of claim 3, wherein the following relationships are further satisfied:
TD≧−4%, and MD≦−1%

5. The method of claim 3, wherein the following relationship is further satisfied:
MD1≦−1%
wherein MD1 is represented by the following formula:
MD1≡(transporting speed of film at the time when the film
is wound around the take-up spool/transporting speed of
film at the time when the residual solvent content of the
film is 30% by weight−1)×100(%)

6. The method of claim 4, wherein the following relationship is further satisfied:
MD1≦−1%
wherein MD1 is represented by the following formula:
MD1≡(transporting speed of film at the time when the film
is wound around the take-up spool/transporting speed of
film at the time when the residual solvent content of the
film is 30% by weight−1)×100(%)

7. The method of claim 3, further comprising the step of stretching the film in the transverse direction between the step of peeling the film from the support and the step of winding the film around the take-up spool, wherein the following relationship is satisfied:
TD1≧−6%,
wherein TD1 is represented by the following formula:
TD1≡(width of film immediately before stretched/width of film immediately before peeled from the support−1)×100(%)

8. The method of claim 4, further comprising the step of stretching the film in the transverse direction between the step of peeling the film from the support and the step of winding the film around the take-up spool, wherein the following relationship is satisfied:
TD1≧−6%,
wherein TD1 is represented by the following formula:
TD1≡(width of film immediately before stretched/width of film immediately before peeled from the support−1)×100(%)

9. The method of claim 5, further comprising the step of stretching the film in the transverse direction between the step of peeling the film from the support and the step of winding the film around the take-up spool, wherein the following relationship is satisfied:
TD1≧−6%,
wherein TD1 is represented by the following formula:
TD1≡(width of film immediately before stretched/width of film immediately before peeled from the support−1)×100(%)

10. The method of claim 3, which further comprises at least one step of stretching the film in the transverse direction at a stretching ratio of not more than 5% between the step of peeling the film from the support and the step of winding the dried film around the take-up spool.

11. The method of claim 4, which further comprises at least one step of stretching the film in the transverse direction at a stretching ratio of not more than 5% between the step of peeling the film from the support and the step of winding the dried film around the take-up spool.

12. The method of claim 5, which further comprises at least one step of stretching the film in the transverse direction at a stretching ratio of not more than 5% between the step of peeling the film from the support and the step of winding the dried film around the take-up spool.

13. The method of claim 6, which further comprises at least one step of stretching the film in the transverse direction at a stretching ratio of not more than 5% between the step of peeling the film from the support and the step of winding the dried film around the take-up spool.

14. A cellulose ester film manufactured by the method of any one of claims 1 through 13.

15. A polarizing plate comprising a protective film comprised of the cellulose ester film as described in claim 14.
